(19) United States
(12) Patent Application Publication
(10) Pub. No.: US 2014/0047309 A1
(43) Pub. Date: Feb. 13, 2014

(54) APPARATUS AND METHOD FOR SYNCHRONIZING CONTENT WITH DATA

(71) Applicant: Electronics and Telecommunications Research Institute, Daejeon (KR)

(72) Inventors: Hyun Cheol KIM, Daejeon (KR); Ji Hoon CHOI, Daejeon (KR); Ji Hun CHA, Daejeon (KR); Jin Woong KIM, Daejeon (KR)

(73) Assignee: Electronics and Telecommunications Research Institute, Daejeon (KR)

(21) Appl. No.: 13/956,600

(22) Filed: Aug. 1, 2013

(30) Foreign Application Priority Data
Aug. 9, 2012 (KR) 10-2012-0087179

(51) Int. Cl. G06F 17/22

(52) U.S. Cl. CPC G06F 17/22
USPC 715/203

(57) ABSTRACT

Provided is an apparatus and method for synchronizing content with data that may extract content feature information of the content, and control synchronization by comparing the content feature information and data feature information described in the data.

### CROSS-REFERENCE TO RELATED APPLICATION

This application claims the benefit of Korean Patent Application No. 10-2012-0087179, filed on Aug. 9, 2012, in the Korean Intellectual Property Office, the disclosure of which is incorporated herein by reference.

### BACKGROUND

1. Field of the Invention

The present invention relates to an apparatus and method for synchronizing audio and video (AV) content with data.

2. Description of the Related Art

Recently, broadcasting has evolved to receive and consume data through not only a communication network but also a broadcasting network, simultaneously.

When a temporal correlation exists between broadcast content received through the broadcasting network and data received through the communication network, the broadcast content and the data may need to be synchronized with each other before being played.

However, performing accurate synchronization between a program to be broadcast and the data received via the communication network may be difficult. At present, synchronization is used for providing an electronic program guide (EPG) or broadcast program information.

Current digital broadcast content may be multiplexed and transmitted based on a moving picture experts group (MPEG)-2 transport stream standard. The MPEG-2 transport stream may include time information to synchronize an audio and a video included in the transport stream.

The time information may indicate a decoding point in time and a presentation point in time of the audio and the video, based on a clock reference. However, such points in time may correspond to relative times. Accordingly, verifying an accurate time at which a corresponding program is started, and a progress of the program may be impossible.

Accordingly, in a case of typical digital broadcast content, although data is received through a communication network, the data may fail to be synchronized accurately with a broadcast program transferred through a broadcasting network, and fail to be displayed properly.

For example, in order to play subtitles by synchronizing subtitle data with audio and video (AV) content transferred through the broadcasting network after the subtitle data is downloaded through the communication network, a terminal may need to verify when and which subtitles are to be displayed. However, the terminal may have difficulties in verifying such information.

A typical subtitle file may include a sentence in subtitles, and a time at which the sentence is to be output. The time may indicate a time having passed after the content is played.

In this instance, an accurate start time of the content may be necessary for synchronizing and playing the subtitles. However, verifying an accurate start time of broadcast content being transmitted through the broadcasting network may be difficult and thus, synchronized subtitles may fail to be provided through the communication network.

### SUMMARY

According to an aspect of the present invention, there is provided an apparatus for synchronizing content with data, the apparatus including a storage unit to store data feature information described in the data, a feature information extracting unit to extract content feature information of the content, and a data processing unit to control synchronization by comparing the data feature information and the content feature information.

The apparatus may further include a content processing unit to perform inverse-multiplexing or decoding on the content.

The data processing unit may extract data corresponding to identical feature information, by comparing the data feature information and the content feature information.

The apparatus may include a play unit to play the content and the data.

The content feature information may include information that distinguishes one frame of a video from another frame of the video, and information that distinguishes one section of an audio from another section of the audio.

The content feature information may include at least one of a vertical location of a frame, a horizontal location of the frame, a pixel value, a difference in pixel values, a motion vector, and a frequency.

The data processing unit may synchronize the content with the data, without use of time information included in a transport protocol.

The data may correspond to at least one of a text, an image, video, and audio into which the content feature information is to be inserted.

The content feature information may be configured independently, rather than being inserted into the data.

The feature information extracting unit may receive a type of the content feature information from the data processing unit, and extracts content feature information corresponding to the received type.

According to another aspect of the present invention, there is also provided a method of synchronizing content with data, the method including storing data feature information described in the data, extracting content feature information of the content, and controlling synchronization by comparing the data feature information and the content feature information.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of an apparatus for synchronizing content with data according to an embodiment of the present invention;

FIG. 2 is a flowchart illustrating a method of synchronizing content with data according to an embodiment of the present invention; and

FIG. 3 is a diagram illustrating a synchronizing process using a vertical location of a video, a horizontal location of the video, and a pixel value at each corresponding location as feature information according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

When it is determined that a detailed description is related to a related known function or configuration which may make the purpose of the present invention unnecessarily ambiguous in the description of the present invention, such a detailed description will be omitted. Also, terminologies used herein are defined to appropriately describe the exemplary embodiments of the present invention and thus may be changed depending on a user, the intent of an operator, or a custom. Accordingly, the terminologies must be defined based on the following overall description of this specification.

According to an embodiment of the present invention, there is provided an apparatus and method for synchronizing content with data that may synchronize audio and video (AV) content with data, irrespective of a type of transport network, by inserting feature information of the AV content to be synchronized with the data, into the data to be synchronized.

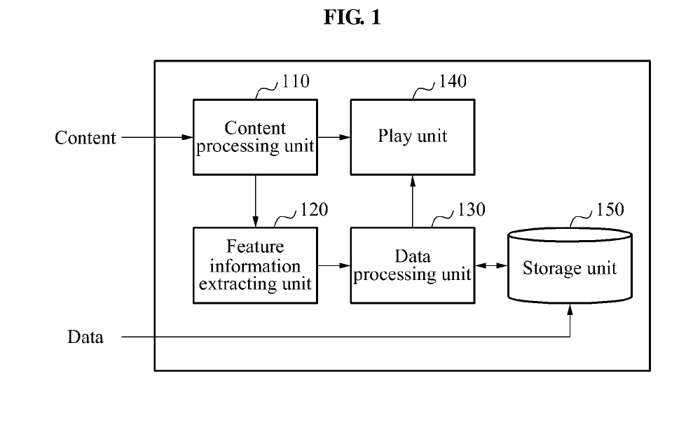

FIG. 1 is a block diagram illustrating a configuration of an apparatus for synchronizing content with data according to an embodiment of the present invention.

Referring to FIG. 1, the synchronizing apparatus may include a storage unit 150 to store data feature information described in the data, a feature information extracting unit 120 to extract content feature information of the content, and a data processing unit 130 to control synchronization by comparing the data feature information and the content feature information.

The synchronizing apparatus may perform inverse-multiplexing or decoding necessary for playing the content, and transfer the inversely-multiplexed content or decoded content to a play unit 140, using a content processing unit 110.

The feature information extracting unit 120 may extract feature information of the decoded content received from the content processing unit 110.

The data processing unit 140 may extract data corresponding to identical feature information, by comparing the data feature information and the content feature information.

The feature information extracting unit 120 may receive a type of the content feature information from the data processing unit 130, and may extract content feature information corresponding to the received type.

For example, when the feature information extracting unit 120 is unaware of the type of content feature information to be obtained, the feature information extracting unit 120 may verify the type of the content feature information from the data processing unit 130.

The feature information extracting unit 120 may transfer the extracted content feature information to the data processing unit 130.

The data processing unit 130 may transfer, to the play unit 140, a portion of the data corresponding to the identical feature information, by comparing the content feature information transferred from the feature information extracting unit 120 and the feature information described in the data.

The play unit 140 may play the content received from the content processing unit 110 and the data received from the data processing unit 130.

Hereinafter, a method of synchronizing content with data according to an example embodiment of the present invention will be described.

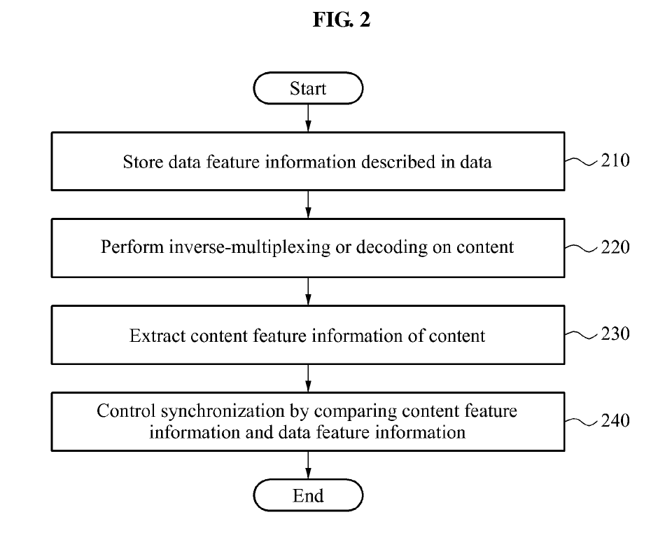

FIG. 2 is a flowchart illustrating a method of synchronizing content with data according to an embodiment of the present invention.

Referring to FIG. 2, in operation 210, an apparatus for synchronizing content with data may perform inverse-multiplexing and decoding on the content.

In operation 220, the synchronizing apparatus may extract feature information of the decoded content.

In operation 230, the synchronizing apparatus may extract data corresponding to identical feature information, by comparing the content feature information and predetermined data feature information.

In operation 240, the synchronizing apparatus may receive and play the decoded content and the extracted data.

The content feature information may include a variety of information, for example, information that distinguishes one frame of a video from another frame of the video, information that distinguishes one section of an audio from another section of the audio, and the like.

The content feature information may include a variety of information, for example, a vertical location of a frame, a horizontal location of the frame, a pixel value, a difference in a pixel value, a motion vector, a frequency, and the like. However, the content feature information is not limited to those mentioned in the preceding, and instead, a variety of feature information obtained through substitutions, transformations, and changes may be available, in addition to the aforementioned feature information.

According to an embodiment of the present invention, the feature information extracting unit 120 of FIG. 1 may analyze a vertical location within a video frame included in the content, a horizontal location within the video frame, and a pixel value corresponding to each location, and may transfer the analyzed information to the data processing unit 130 of FIG. 1.

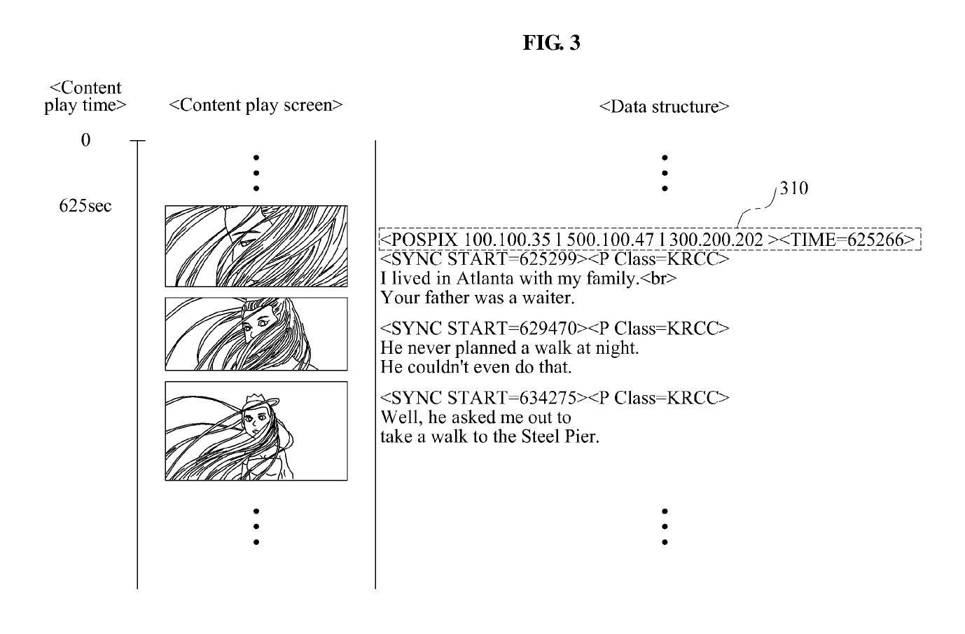

FIG. 3 is a diagram illustrating a synchronizing process using a vertical location of a video, a horizontal location of the video, and a pixel value at each corresponding location as feature information according to an embodiment of the present invention.

Referring to FIG. 3, an apparatus for synchronizing content with data may extract content feature information, using three sets of a vertical location within a video frame, a horizontal location within the video frame, and a pixel value at each location.

For example, according to content feature information 310, a frame of which a pixel value at a location (100, 100) corresponds to 35, a pixel value at a location (500, 100) corresponds to 47, and a pixel value at a location (300, 200) corresponds to 202 may correspond to 625,266 milliseconds (msec).

In this instance, the synchronizing apparatus may perform synchronization on subtitles to be displayed at <SYNC START=625299>, and output the synchronized subtitles.

The data processing unit 130 of FIG. 1 may synchronize the content with the data, without use of time information included in a transport protocol.

For example, once the synchronizing apparatus performs synchronization using the method of FIG. 3, the synchronizing apparatus may perform synchronization using the existing method in subsequent processes, without use of content feature information.

When the content feature information is used, the synchronizing apparatus may perform synchronization without use of time information included in a transport protocol. Accordingly, the synchronizing apparatus may perform synchronization, irrespective of a type of a network through which content and data are transmitted.

The synchronizing apparatus may support synchronization at an accuracy of frame units and thus, the synchronizing apparatus may be utilized for various synchronization services which require an accuracy, as well as subtitles.

The data is not limited to subtitle data, and instead, may correspond to a text, an image, video, and audio into which the content feature information may be inserted. That is, there may be no limitations to a format of the data.

The content feature information may be configured independently, rather than being inserted into the data.

For example, when it is difficult to insert AV content feature information into the data, directly, the synchronizing apparatus may configure a feature information file, independently.

According to an embodiment of the present invention, when editing is performed to cut off a predetermined portion of AV content although the AV content is not transmitted through a broadcasting network, discordant synchronization may be reestablished.

According to an embodiment of the present invention, synchronization may be performed irrespective of a type of a network through which AV content and data are transmitted, and the AV content may be synchronized with the data already generated although the AV content is edited.

According to an embodiment of the present invention, a synchronization service may be provided in a connected television (TV), a smart TV, and the like, and the data already generated may be utilized in the edited AV content.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for synchronizing content with data, the apparatus comprising:
a storage unit to store data feature information described in the data;
a feature information extracting unit to extract content feature information of the content; and
a data processing unit to control synchronization by comparing the data feature information and the content feature information.

2. The apparatus of claim 1, further comprising:
a content processing unit to perform inverse-multiplexing or decoding on the content.

3. The apparatus of claim 1, wherein the data processing unit extracts data corresponding to identical feature information, by comparing the data feature information and the content feature information.

4. The apparatus of claim 1, further comprising:
a play unit to play the content and the data.

5. The apparatus of claim 1, wherein the content feature information comprises information that distinguishes one frame of a video from another frame of the video, and information that distinguishes one section of an audio from another section of the audio.

6. The apparatus of claim 1, wherein the content feature information comprises at least one of a vertical location of a frame, a horizontal location of a frame, a pixel value, a difference in pixel values, a motion vector, and a frequency.

7. The apparatus of claim 1, wherein the data processing unit synchronizes the content with the data, without use of time information included in a transport protocol.

8. The apparatus of claim 1, wherein the data corresponds to at least one of a text, an image, video, and audio into which the content feature information is to be inserted.

9. The apparatus of claim 1, wherein the content feature information is configured independently, rather than being inserted into the data.

10. The apparatus of claim 1, wherein the feature information extracting unit receives a type of the content feature information from the data processing unit, and extracts content feature information corresponding to the received type.

11. A method of synchronizing content with data, the method comprising:
storing data feature information described in the data;
extracting content feature information of the content; and
controlling synchronization by comparing the data feature information and the content feature information.

12. The method of claim 11, further comprising:
performing inverse-multiplexing or decoding on the content.

13. The method of claim 11, wherein the controlling comprises extracting data corresponding to identical feature information, by comparing the data feature information and the content feature information.

14. The method of claim 11, further comprising:
playing the content and the data.

15. The method of claim 11, wherein the content feature information comprises information that distinguishes one frame of a video from another frame of the video, and information that distinguishes one section of an audio from another section of the audio.

16. The method of claim 11, further comprising:
synchronizing the content with the data, without use of time information included in a transport protocol.

17. The method of claim 11, further comprising:
configuring the content feature information independently, rather than inserting the content feature information into the data.
